(19) United States
(12) Patent Application Publication
(10) Pub. No.: US 2005/0279227 A1
(43) Pub. Date: Dec. 22, 2005

(54) Injection device

(75) Inventor: Helmut Schroder, Werther (DE)

Correspondence Address: RICHARD M. GOLDBERG, 25 EAST SALEM STREET, SUITE 419, HACKENSACK, NJ, 07601, US

(73) Assignee: Schroder Maschinenbau KG, Werther (DE)

(21) Appl. No.: 11/149,059

(22) Filed: Jun. 9, 2005

(30) Foreign Application Priority Data
Jun. 17, 2004 (DE) 10 2004 029 158.6

(51) Int. Cl. B02B 3/00

(52) U.S. Cl. 99/532

(57) ABSTRACT

Injection device includes a plurality of parallel hollow needles that are reciprocatingly movable in a longitudinal direction thereof relative to a product carrier, and a supply system for supplying, into the hollow needles, a liquid to be injected into the product. Each hollow needle has associated therewith a cleaning needle that is insertable into the hollow needle. A drive mechanism is provided for moving the cleaning needles between a cleaning position, in which they are inserted into the hollow needles, and an injection position, in which they clear the hollow needles for the supply of the liquid.

The invention relates to an injection device comprising a plurality of parallel hollow needles that are reciprocatingly movable in a longitudinal direction thereof relative to a product carrier, and a supply system for supplying, into the hollow needles, a liquid that is to be injected into the product.

A typical example of an injection device of this type is a pickling machine for injecting brine into meat or other food (see for example DE 197 26 187 C1).

In some instances of application, the brine, or more generally, the liquid to be injected, has a relatively high viscosity, or it contains dispersed suspended particles, so that the needles may easily become clogged. For this reason, time-consuming interruptions of the operation are necessary relatively frequently, in order to clean the needles with a scavenging liquid, for example (see also DE 195 30 046 C2).

It is an object of the invention to provide an injection device which permits a simple and quick cleaning of the needles.

According to the invention, this object is achieved by the features that each hollow needle has associated therewith a cleaning needle that is insertable into the hollow needle, and that a drive system is provided for moving the cleaning needles between a cleaning position in which they are inserted into the hollow needles, and an injection position, in which they clear the hollow needles for supplying the liquid.

Thus, for cleaning the hollow needles, it is only necessary to activate the drive system in order to introduce the cleaning needles into the hollow needles, so that any contaminations that may stick to the interior of the hollow needles will be removed. When the cleaning needles are withdrawn again, the injection process may directly be continued.

Useful details and further developments of the invention are indicated in the dependent claims.

Preferably, the hollow needles are formed as so-called cannula, i.e. as needles from which the liquid to be injected does not exit laterally, but only axially through an open end of the needles. The contaminations that have been removed by means of the cleaning needles may then simply be pushed out through the open end of the hollow needles, and there is no risk that lateral exit openings of the hollow needles become clogged.

The hollow needles may, as usual, be provided on a needle carrier that is arranged vertically movably above an intermittently operated conveyer. The supply system for the liquid is then integrated into the needle carrier and may for example be formed by a valve system that is controlled by a relative movement between the needle carrier and a strip-off member that engages the product while the needle carrier is lowered and the needles penetrate further into the product, and which retains the product when the needles are pulled upwardly. When, during the upward stroke of the needle carrier, the strip-off member reaches its lowermost position relative to the needle carrier, the valve interrupts the supply of brine, so that the brine will be injected-only in the operating phases in which the needles actually penetrate the product. Then, the cleaning needles are preferably mounted to a separate cleaning carrier that is movable relative to the needle carrier.

When the liquid is injected only during the downward stroke of the needle carrier, the cleaning needles may plunge into the hollow needles already during the upward stroke of the needle carrier. Preferably, however, the upward stroke of the needle carrier is also used for the injection. In this case, the cleaning needles may plunge-in only when the hollow needles are in a position above the product, because otherwise the supply of brine to the product would be interrupted prematurely.

Preferably, a control system is provided which synchronizes the movement of the cleaning carrier with the movement of the needle carrier and preferably also with the cycle of the conveyer. Since the inward and outward plunge movement of the cleaning needles takes a certain time, it is convenient that the cleaning process is not executed in each cycle of the needle carrier, but, for example, only in every fifth cycle. Then, the cycle time of the cleaning carrier is an integral multiple of the cycle time of the needle carrier.

The time during which a new product is fed into a processing position below the needle carrier by means of the conveyer may be utilized for the cleaning process. Then, the control system may provide that the cycle or the conveying speed of the conveyer is somewhat delayed during the cleaning cycles, so that sufficient time is available for the cleaning process.

An embodiment example will now be explained in conjunction with the drawings, wherein:

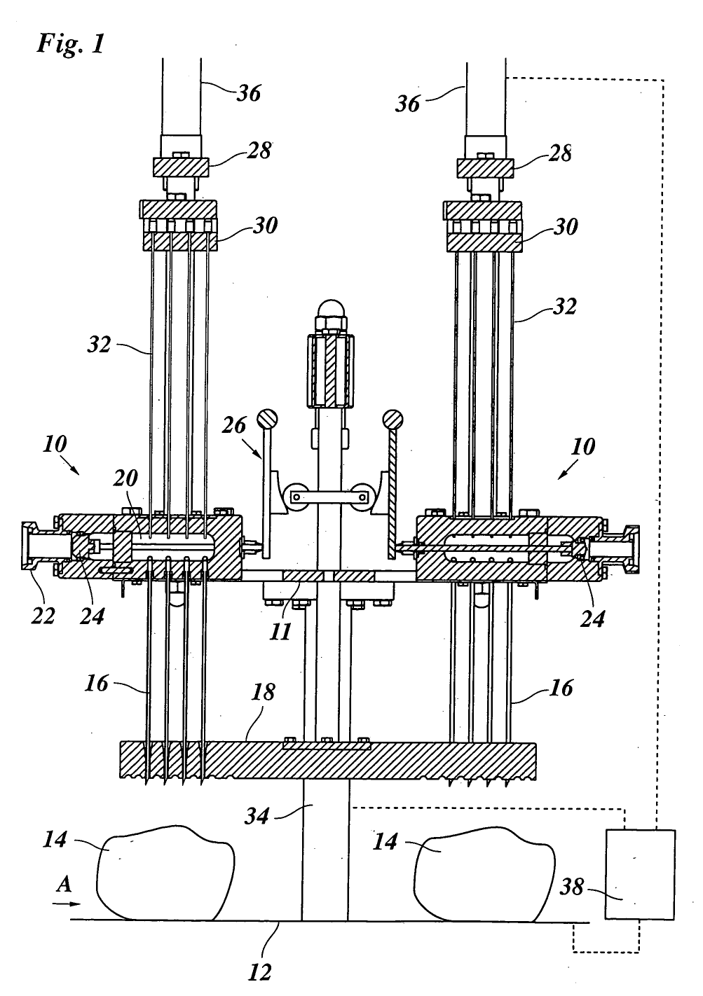

FIG. 1 is a vertical cross-sectional view of essential parts of a pickling machine in a condition immediately before an injection process;

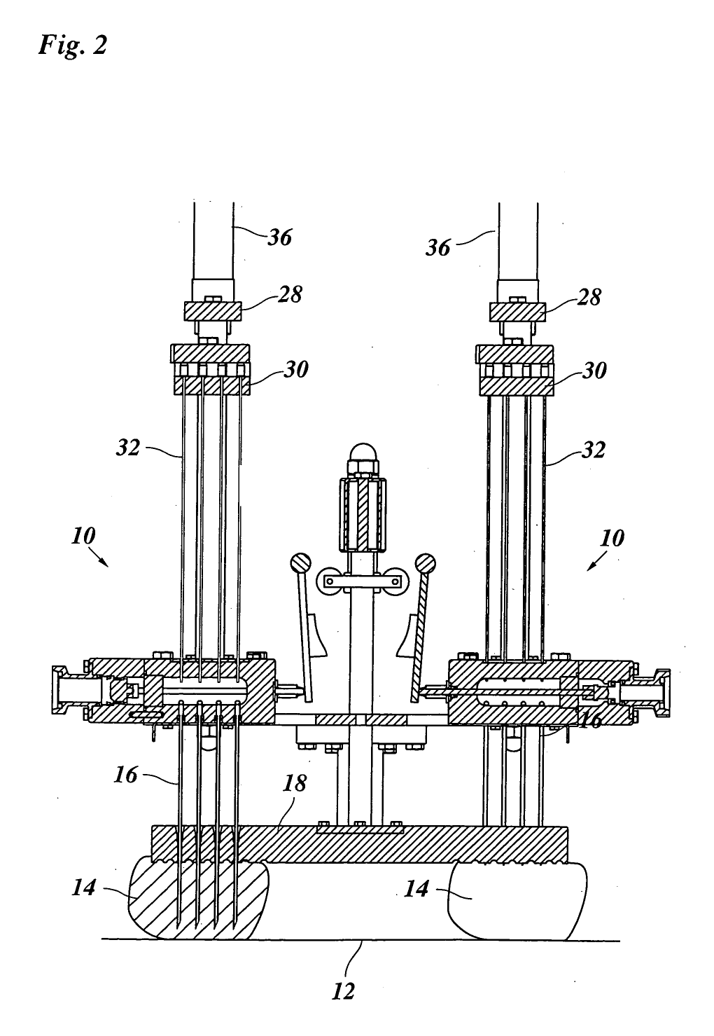

FIG. 2 shows the pickling machine during the injection process;

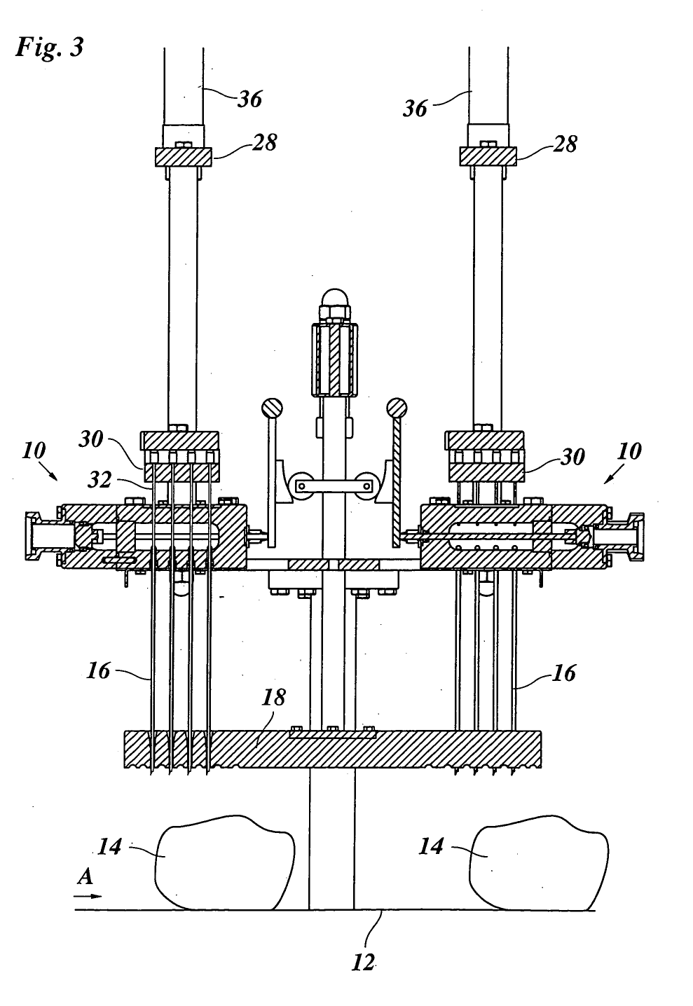

FIG. 3 shows the pickling machine during a cleaning process; and

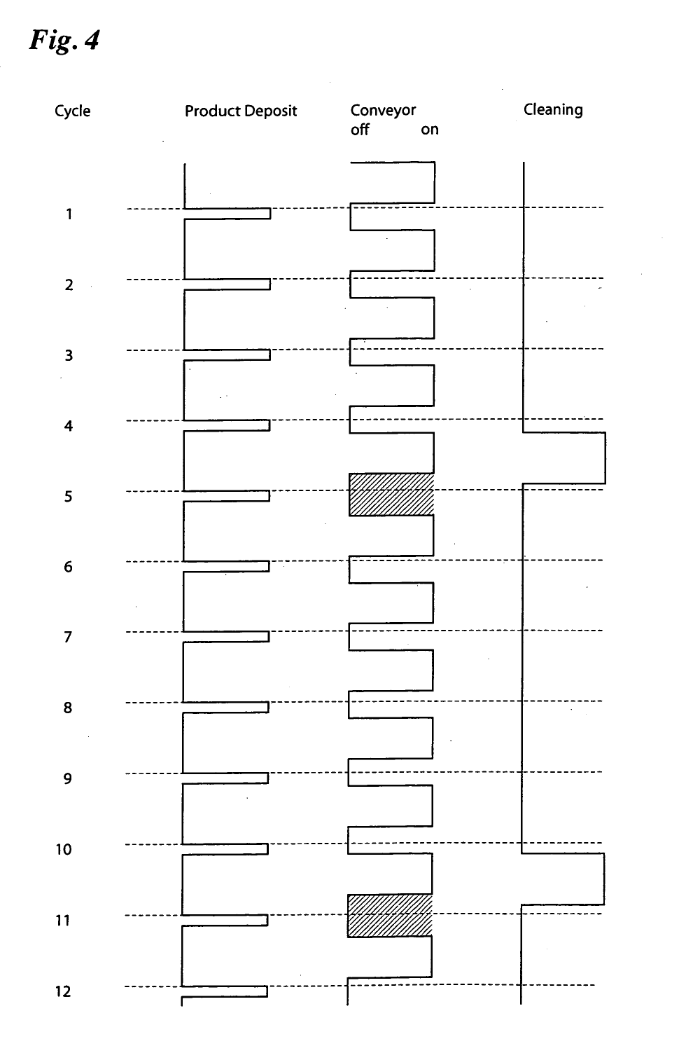

FIG. 4 is a time diagram for explaining the working cycle of the pickling machine.

FIG. 1 shows, as an example for an injection device, a pickling machine with two needle carriers 10 which are mounted to a common frame 11 above a conveyer 12. On the conveyor 12, the product items 14 to be pickled, e.g. ham, are intermittently conveyed in direction of arrow A.

Each needle carrier 10 has a set of hollow needles 16 that extend downwardly and in parallel to one another through a strip-off member 18 and each have an open lower end. The top ends of the hollow needles 16 open into a brine chamber 20 which is supplied with brine through a brine inlet port 22 and a brine valve 24. For controlling the brine valves 24, a cam-type control mechanism 26 is provided, which is actuated by the strip-off member 18.

Two cleaning carriers 30, each of which carries a set of cleaning needles 32, are mounted above the needle register 10 to mounting structures 28 that are fixed relative to the frame. Each of the cleaning needles 32 is associated to one of the hollow needles 16 and passes in liquid-tight manner through the top wall of the brine chamber 20. In the condition shown in FIG. 1, the lower ends of the cleaning needles 32 are located within the brine chambers 20, but upwardly spaced apart from the open top ends of the hollow needles 16. The outer diameter of the cleaning needles 32 is matched to the internal diameter of the hollow needles 16. The cleaning needles 32 may be made of metal or optionally of plastics or any other material. Optionally, they may also be formed as long, thin cleaning brushes, as long as a liquid-tight seal is provided for the passages through the top wall of the brine chambers 20.

The frame 11 carrying the two needles carriers 10 is adapted to be lifted and lowered relative to the conveyer 12 by means of a mechanical, hydraulic or pneumatic drive mechanism 34. The strip-off member 18 is guided on the frame 11 to be movable in vertical direction and is elastically, e.g. pneumatically, biased into the lower end position shown in FIG. 1, in which position the brine valves 24 are held in the closed position by the cam-type control mechanism 26. The cleaning carriers 30 are arranged to be movable in vertical direction relative to the needle carriers 10 by means of hydraulic or pneumatic drive mechanisms 36.

An electronic control system 38 controls the working cycles of the conveyer 12, the drive mechanism 34 for the needle carriers and the drive mechanism 36 for the cleaning carriers 30.

The pickling machine operates as follows. In FIG. 1, the product items 14 have been conveyed by means of the conveyer 12 into positions, in which they are located directly below the hollow needles 16. Then, the conveyer 12 is stopped, and the needle carriers 10 are lowered together with the cleaning carriers 30, so that the hollow needles 16 penetrate into the product items 14, as has been shown in FIG. 2. Meanwhile, the strip-off member 18 settles on top of the product items 14 and is then moved upwardly relative to the needle carriers 10, so that the brine valves 24 are opened by the cam-type control mechanism 26. In this way, the brine is injected under pressure into the product items 14′. During the subsequent upward stroke of the needle carrier 10, the brine valves 24 are closed again, as soon as the hollow needles 16 withdraw from the product items 14 and the strip-off member 18 is lifted from the product.

In order to prevent the hollow needles 16 from becoming clogged, a cleaning process is executed from time to time, as is illustrated in FIG. 3. This cleaning process is executed at a time when the needle carriers 10 are in the lifted position and the product items 14 are discharged by means of the conveyer 12. In this condition, the cleaning carriers 30 are lowered by means of the drive mechanisms 36, so that the cleaning needles 32 plunge into the hollow needles 16. In FIG. 3, the cleaning carriers 30 are in the lowermost position; and the lower ends of the cleaning needles 32 are approximately flush with the lower ends of the hollow needles 16, so that any contaminations that may have remained within the hollow needles 16 are pushed-out through the open and non-tapered lower ends of the hollow needles. Subsequently, the cleaning carriers 30 are lifted again into the position shown in FIG. 1, which ends the cleaning process.

The cleaning needles 32 are replaceably held in the cleaning carriers 30 with thickened heads, so that they may be exchanged upon demand.

In principle, the cleaning process may be executed in each cycle of the needle carriers 10. In practice, however, it is generally sufficient to execute the cleaning process in larger intervals, for example, only in every fifth cycle of the needle carriers. Since the cleaning process commences only after the hollow needles 16 have been withdrawn again from the product items 14, the brine can also be injected into the product items 14 during the upward stroke of the needle carriers 10, without the supply of brine to the hollow needles 16 being interrupted by the cleaning needles 32. Since, however, the lifting and lowering of the needle carriers 30 takes a certain time, the time required for the working cycles with cleaning operation may be somewhat larger than the time for the working cycles without cleaning operation. For this reason, the control system 38 is arranged such that in the cycles, in which the cleaning process is to take place, the conveying speed or the conveying cycle of the conveyer 12 is somewhat delayed, so that the cycles of the conveyer and the needle carriers 10 remain synchronized with one another. Nevertheless is it possible to deposit the product items 14 on the conveyer 12, by means of a supply mechanism which has not been shown, with a fixed cycle rate, while assuring that the product items will have uniform spacings on the conveyer 12, so that they may be brought under the needle carriers 10 in the correct positions. This has been exemplified in FIG. 4. For the sake of simplicity, it shall be assumed here that two product items 14 are respectively placed onto the conveyer 12 by means of the supply mechanism in such a manner that the spacing between the two product items 14 corresponds to the spacing between the two needle carriers 10.

In FIG. 4, the time sequence of twelve working cycles of the device has been illustrated in a time diagram. The left curve in FIG. 4 indicates the cycle of the supply mechanism. At each pulse of this curve, two product items 14 are laid onto the conveyer. The center curve indicates the cycle of a conveyer 12. In each on-cycle, the conveyer 12, a conveyer belt, for example, is moved by a distance which has been selected such that two new product items 14 are supplied in the correct positions below the needle carriers 10. Then, the conveyer 12 is stopped for a time interval during which the injection process takes place in accordance with FIG. 2. The right curve in FIG. 4 shows the cleaning cycles of the cleaning carriers 30. It can be seen that a cleaning process is carried out every fifth working cycle of the needle carriers, and that each cleaning cycle starts when the injection process is completed and the on-cycle of the conveyer 12 commences. However, the cleaning process takes somewhat longer than the on-cycle of the conveyer. For this reason, after each on-cycle during which a cleaning process takes place, the conveyer 12 pauses for a somewhat longer time, as has been shown by hatching in FIG. 4. Thus, it is assured that, after the cleaning process has been completed, sufficient time remains for the next injection process, before the conveyer starts to move again.

Thus, the working cycles of the conveyer 12 have different durations, depending upon whether or, not a cleaning process takes place. In contrast, the working cycles of the supply mechanism (left curve in FIG. 4) have a constant period which coincides with the average period of the working cycles of the conveyer 12. In cycle 1, the supply operation takes place as soon as the conveyer has stopped. In cycle 2, the supply operation is slightly delayed relative to the stopping of the conveyer, and in the subsequent cycles 3, 4 and 5, the supply operation shifts progressively towards the end of the off-period of the conveyer. In cycle 5, however, the conveyer has a longer off-period, so that, in the subsequent cycle 6, the time relation is again the same as in cycle 1. In the subsequent cycles, these operations are repeated periodically. Thus, it is assured that the product items 14 can be placed onto the conveyer 12 with a constant cycle time and are nevertheless always supplied in the correct positions, in spite of the different durations of the working cycles of the conveyer 12.

1. Injection device comprising:
a plurality of parallel hollow needles that are reciprocatingly movable in a longitudinal direction thereof relative to a product carrier,
a supply system for supplying, into the hollow needles, a liquid to be injected into a product on the product carrier,
a cleaning needle associated with each hollow needle and that is insertable into the respective hollow needle, and
a drive mechanism for moving the cleaning needles between a cleaning position, in which they are inserted into the hollow needles, and an injection position, in which they clear the hollow needles for the supply of the liquid.

2. Injection device according to claim 1, further comprising a needle carrier and a cleaning carrier, wherein:
the plurality of hollow needles are respectively mounted on the needle carrier which also includes the supply system for the liquid, and
a plurality of said cleaning needles are respectively mounted on the cleaning carrier, and
further comprising a drive mechanism for providing relative movement of the cleaning carrier to the needle carrier.

3. Injection device according to claim 2, wherein:
the needle carrier includes a chamber,
open top ends of the hollow needles are located in the chamber formed within the needle carrier, and
the cleaning needles pass through a top wall of the chamber in a liquid-tight manner.

4. Injection device according to claim 1, wherein the hollow needles are cannula which each have only a single exit opening at a lower end thereof.

5. Injection device according to claim 1, wherein the product carrier includes a conveyer arranged to be driven intermittently.

6. Injection device according to claim 5, further comprising a control system which synchronizes a cycle of the conveyer with a cycle of the hollow needles and a cycle of the cleaning needles.

7. Injection device according to claim 6, wherein a period of the cycle of the cleaning needles is a multiple of a period of the cycle of the hollow needles.

8. Injection device according to claim 7, wherein the cleaning needles reach a cleaning position thereof only after the hollow needles have been withdrawn from the product.

9. Injection device according to claim 8, wherein the control system is adapted to delay at least one of a transport speed and the cycle of the conveyer for each working cycle of the cleaning needles.
